(19) United States
(12) Patent Application Publication
(10) Pub. No.: US 2002/0112005 A1
(43) Pub. Date: Aug. 15, 2002

(54) VIDEO E-MAIL KIOSK

(76) Inventor: CHARLES NAMIAS, BOXBOROUGH, MA (US)

Correspondence Address: HOGAN & HARTSON LLP, IP GROUP, COLUMBIA SQUARE, 555 THIRTEENTH STREET, N.W., WASHINGTON, DC, 20004, US

(21) Appl. No.: 09/139,637

(22) Filed: Aug. 25, 1998

(51) Int. Cl. G06F 17/00; G06F 15/16

(52) U.S. Cl. 709/206; 705/401

(57) ABSTRACT

A method and apparatus for providing a video e-mail kiosk for creating and sending video e-mail messages such as full motion videos or still snapshots. The method comprises recording a video message, requesting an e-mail address of an intended recipient, and sending the video message to the intended recipient. The apparatus comprises a display device capable of displaying video and computer graphics, an input device capable of accepting input from a user, a digital video camera, a microphone, a digital network communications link, and a processor connected to the display device, the input device, the digital video camera, the microphone, and the digital network communications link, and capable of accepting an input from a user and generating display output, and further capable of converting a video input from the digital video camera and an audio input from the microphone into a digital video e-mail message and transmitting the digital video e-mail message over the digital network communications link.

### BACKGROUND OF THE INVENTION

1. Field of the Invention

The present invention relates to an interactive kiosk for creating and sending video information over a communication network to a recipient as an electronic mail or “e-mail” message.

2. Description of Background Art

Digital communications networks, such as the Internet, are designed for the exchange of large quantities of information in a digital form. Because digital networks can communicate large amounts of data, they are rapidly gaining in popularity. Digital information can be sent almost instantaneously and practically anywhere. In addition, the number of users is skyrocketing as more and more people discover that digital communications, such as e-mail, are easy to use, fast, and relatively inexpensive. Email has several advantages over previous modes of communication, such as the instantaneousness of a telephone call and the ability to wait for the recipient like a letter.

A user creates an e-mail message by creating message information and specifying the address of a recipient. The address, and other information such as the size and format of the message, are saved in a header file that is appended to the message information. The address is a unique identifier which instructs routing computers where to send the message. When the message is transmitted, it is sent from the host computer (the user's computer) to the recipient. The message will usually be routed through several intermediate computers that act as relay stations.

Although traditionally used for text messages, e-mail is capable of transferring any type of digital information, including digital audio, graphics, and video. In the recent past, transmission of video over digital networks was hampered by the large quantity of data that was required to be transmitted, and by the relatively limited bandwidth of most digital networks. The growth of the capabilities of digital communications networks and the capabilities of personal computers has now enabled graphical and pictorial information to be widely communicated. This is beginning to be true for video transmission also.

Video clips and messages on the Internet are becoming more popular as computer and network capabilities expand, and also as more people discover their use. Video is popular for advertising and educational purposes, and will likely become popular as a method of personal communication.

Video communications and other types of visual communications have long been sought and desired by the general public. Images of videophones and wrist televisions are in existence. Reducing a message, scene, or event to writing in most cases necessitates a loss of non-verbal communication, emotional content, or other significance. Many forms of current communication, such as communication by telephone, are also lesser substitutes for video or other types of visual communications.

The lack of video communication and other types of visual communications is most readily apparent when the event desired to be shared has family or emotional significance. The birth of a child, the relaying of personal news, or contact with family or friends at a distance is best accomplished by visual communication. Although many forms of digital communications are possible, they are often confined to textual or other limited communications, such as the e-mail transmission of text and graphics.

What is needed therefore is a method and apparatus for creating and sending video e-mail messages.

### SUMMARY OF THE INVENTION

It is therefore an object of the invention to provide a video e-mail kiosk capable of creating and recording a video message and transmitting the message to a recipient via e-mail.

It is another object of the invention to provide a video email kiosk capable of recording a video e-mail message at the prompting of a user.

It is yet another object of the invention to provide a video e-mail kiosk capable of providing a recorded full motion video or a still snapshot e-mail message for review by a user.

It is an object of the invention to provide a video e-mail kiosk capable of re-recording a full motion video or still snapshot e-mail message at the option of a user.

Another object of the invention is to provide a video e-mail kiosk capable of requesting an e-mail address of a recipient.

An object of the invention to provide a video e-mail kiosk capable of sending a full motion video or still snapshot e-mail message to one or more designated e-mail recipients.

It is an object of the invention to provide a video e-mail kiosk capable of verifying the validity of the entered address of an e-mail recipient.

An object of the invention is also to provide a video e-mail kiosk capable of accepting a payment from the user.

A computer-implemented method for creating and sending a video e-mail message is provided according to a first aspect of the invention. The method comprises the steps of recording a video message, requesting an e-mail address of an intended recipient, and sending the video message to the intended recipient.

A video e-mail kiosk for creating and sending a video e-mail message is provided according to a second aspect of the invention. The video e-mail kiosk comprises a display device capable of displaying video and computer graphics, an input device capable of accepting input data from a user, a digital video camera, a microphone, a digital network communications link, and a processor connected to the display device, the input device, the digital video camera, the microphone, and the digital network communications link, and capable of accepting input data from a user and generating display output, and further capable of converting a video input from the digital video camera and an audio input from the microphone into a digital video e-mail message and transmitting the digital video e-mail message over the digital network communications link.

The above and other objects, features and advantages of the present invention will become clear from the following description of the preferred embodiment thereof, taken in conjunction with the accompanying drawings.

### BRIEF DESCRIPTION OF THE DRAWINGS

FIG. 1 shows a video e-mail kiosk of the present invention;

FIG. 2 shows an inactive screen that is displayed when the video e-mail kiosk is idle;

FIG. 3 shows a record screen that is displayed when a user has activated the video e-mail kiosk;

FIG. 4A shows a preview screen that is displayed after a user has recorded a video message;

FIG. 4B shows a processing wait screen that is displayed during video processing;

FIG. 5 shows an address screen that is displayed when a user is prompted to enter a recipient's e-mail address;

FIG. 6 shows a payment screen that is displayed when a user is prompted to tender payment;

FIG. 7 shows a final screen that is displayed to a user when the video e-mail transaction is completed; and

FIGS. 8A-8D is a flowchart of the method of operation of the video e-mail kiosk.

### DETAILED DESCRIPTION OF THE PREFERRED EMBODIMENTS

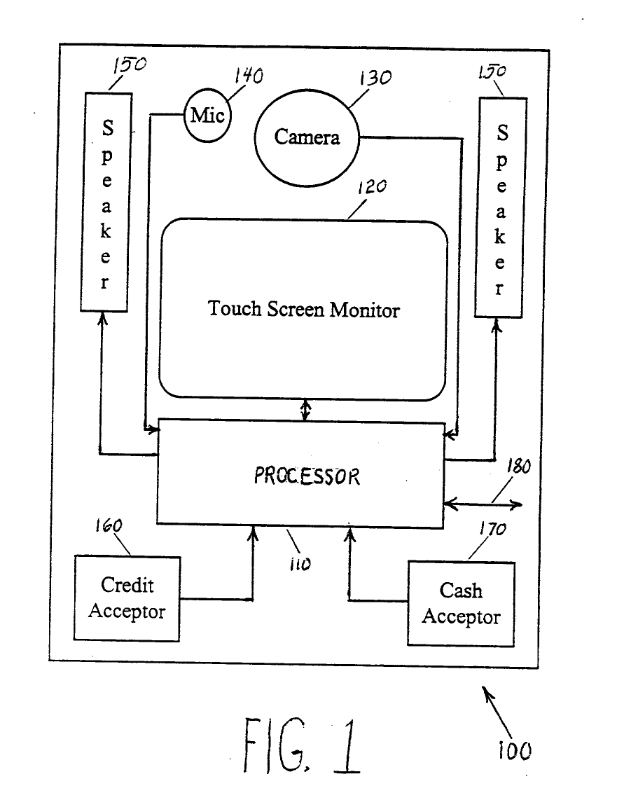

Referring now to FIG. 1, there is shown a preferred embodiment of a video e-mail kiosk 100 of the present invention. The video e-mail kiosk 100 comprises a digital processor 110, a touch-sensitive screen monitor 120, a digital video camera 130, a microphone 140, audio speakers 150, a credit card acceptor 160, a cash acceptor 170, and a digital network communications link 180. Preferably, the digital network communications link 180 is an Internet connection. In one alternative embodiment, a general purpose video monitor (not shown) and a conventional keyboard (not shown) may be substituted for the touch-sensitive screen monitor 120. In another alternative embodiment, the audio speakers 150 may be replaced by a single audio speaker or no audio speakers, as the playback of audio is desired but not necessary for the review of a recorded video message. In yet another alternative embodiment, the digital video camera 130 is of a type that can capture a still digital photograph, whereby an e-mail message can be created containing a still snapshot.

The processor 110 may be any type of general purpose computer, such as a personal computer (PC), minicomputer, or other microprocessor-based type of computer. The processor 110 is connected to the touch-sensitive screen monitor 120, the digital video camera 130, the microphone 140, the audio speakers 150, the credit card acceptor 160, and the cash acceptor 170. The processor 110 receives user inputs from the touch-sensitive screen monitor 120, sends display output to the touch-sensitive screen monitor 120, receives and stores digital video input from the digital video camera 130 and audio input from the microphone 140, and conducts a payment transaction by means of either the credit card acceptor 160 or the cash acceptor 170. The processor 110 is also capable of replaying stored video (full motion or still snapshots) and audio, creating a full motion video or snapshot e-mail message containing the stored full motion video and audio or stored snapshot, and transmitting the message to a recipient or recipients via the digital network communications link 180.

The processor 110 records the video e-mail message to a memory, which preferably is internal random access memory (RAM), but alternatively may be recorded onto optical or magnetic disk, or equivalents thereof. The processor 110 forms an e-mail message having the recorded video and audio segments or snapshot as the body of the message, and adds the address or addresses of the recipient(s) as entered by the user by touching alphanumeric key icons on the touch-sensitive screen monitor 120. The video e-mail message may be formatted in any one of a number of known formats, such as MPEG, AVI, MOV, or the like. Likewise, the video message may be formatted in any one of a number of known formats, such as BMP, JPG, GIF, or the like. The processor 110 prompts the user to enter payment, which can be made through either the credit card acceptor 160 or the cash acceptor 170. The processor 110 establishes a connection to a digital network through the digital network communications link 180, and transmits the full motion video or still snapshot e-mail message over the digital network.

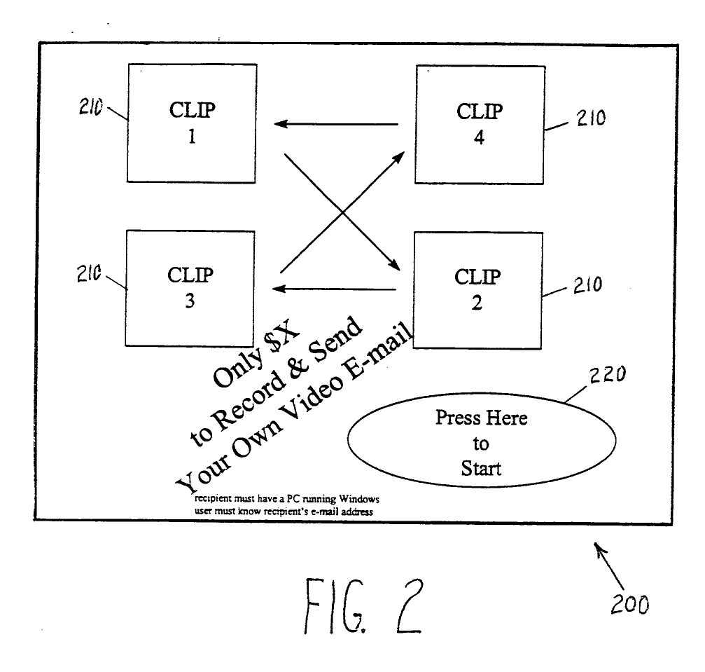

FIG. 2 shows an inactive screen display 200 of the video e-mail kiosk 100 when the kiosk 100 is in an inactive or “stand-by” mode; that is, no user is currently conducting a transaction. The inactive screen display 200 in the preferred embodiment displays information about the video e-mail service, displays sample full motion video or still snapshot messages 210, and has a start button 220 whereby a user may start the process of creating and sending a video e-mail message by touching the start button 220, which sends a “wake-up” signal to the processor 110.

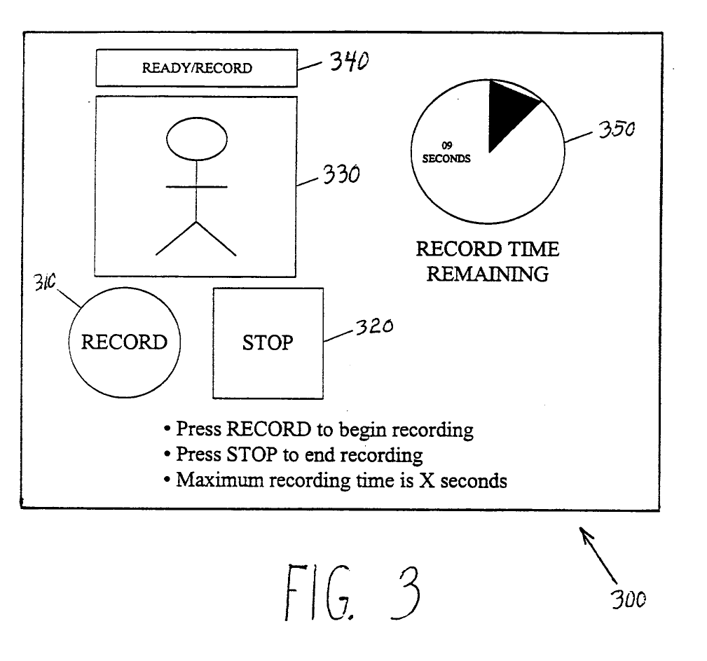

FIG. 3 shows a record screen display 300 that is displayed when a user has activated the video e-mail kiosk 100 by pressing the start button 220 of the inactive screen display 200. The record screen 300 contains information explaining the operation of this stage of the process, a record button 310, a stop button 320, an image window 330, a status window 340, and a time remaining display 350. A user can initiate the start of recording by pressing the record button 310, and may halt recording before the expiration of the recording period by pressing the stop button 320. The status window 340 tells the user when the video e-mail kiosk 100 is recording and when it is ready to record. When the user presses the record button 310, the status window 340 will change from displaying “ready” to displaying “record.” The recording may be monitored by the user by means of the image window 330 and the time remaining display 350. The time remaining display 350 graphically shows the user how much recording time is left. The stop button 220 will stop the recording process if the time remaining display 350 indicates that the recording is still in process, but will have not effect if the recording time has expired. In an alternative embodiment, the video recording may be replaced by the taking of a still digital snapshot when the record button 310 is pushed.

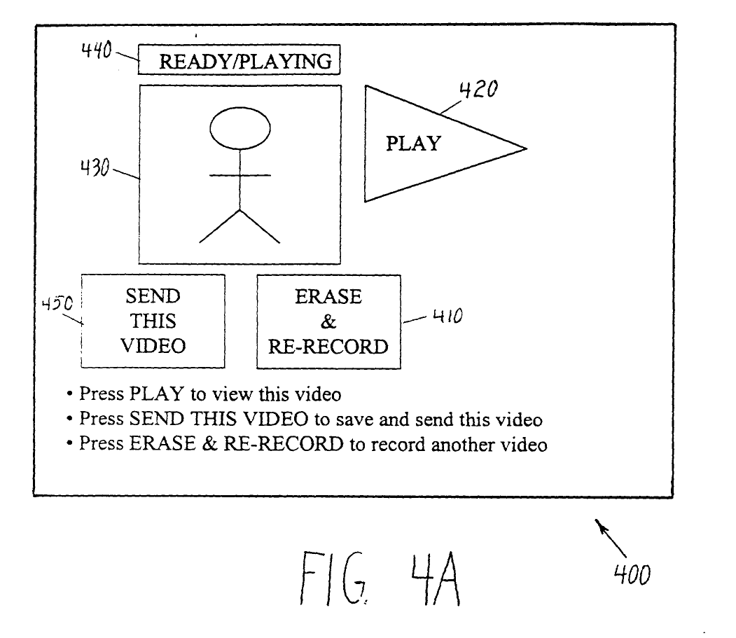

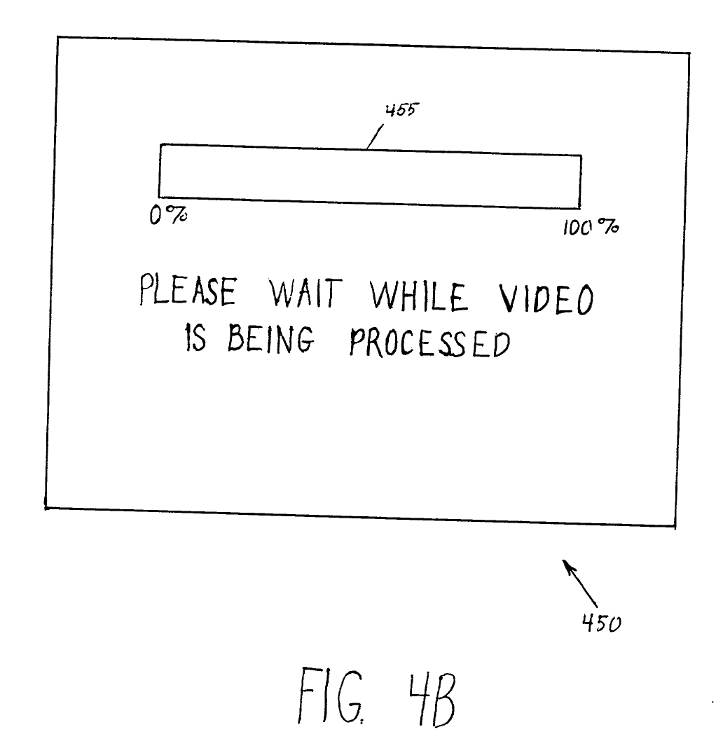

FIG. 4A shows a preview screen 400 that is displayed after a full motion video or still snapshot message has been recorded. The preview screen 400 contains text explaining the operation of this stage of the video recording process, an erase button 410, a play button 420, an image window 430, a status window 440, and a send button 450. The preview screen 400 is presented to the user after the video message has been recorded, and allows the user to review the recorded full motion video or still snapshot message and decide if the recorded message is acceptable. If the recorded message is not acceptable, the preview screen 400 allows the user to erase and re-record the video message by pressing the erase button 410. Alternatively, the preview screen 400 allows the user to erase and re-take the video message by pressing the erase button 410. If the user presses the erase button 410, the display reverts to the record screen 300, where the user may again record a full motion video or still snapshot message.

In order to decide whether to accept or reject the recorded video message, the user may press the play button 420 and review the recorded message on the image screen 430 (the user may not need to press any button to review a still snapshot message, as that captured message may already be displayed). The status window 440 reflects the current status of the image window 430. The status window 440 may display “ready” if the recorded video is not playing, and may display “playing” after the play button 420 has been pressed and while the video message is yet playing. If, after reviewing the video message, the user is satisfied with the video message, the send button 450 may be pressed to advance to the next display screen and the next step.

FIG. 4B shows a processing wait screen 450 that is displayed if the user presses the play button 420 in order to review the recorded video message. The processing wait screen 450 contains text instructing the user to wait for the video message to be processed, and a processing status window 455.

The processing wait screen 450 is displayed while the recorded video is being processed, e.g., compressed. As will be recognized by one skilled in the art, the video message may be processed using a data compression algorithm to reduce the size of the video message for storage and transmission. The processing status window 455 indicates the time remaining in the processing procedure, and in the preferred embodiment shows the percentage of compression time remaining. Alternatively, the processing status window 455 may display discrete units of time remaining.

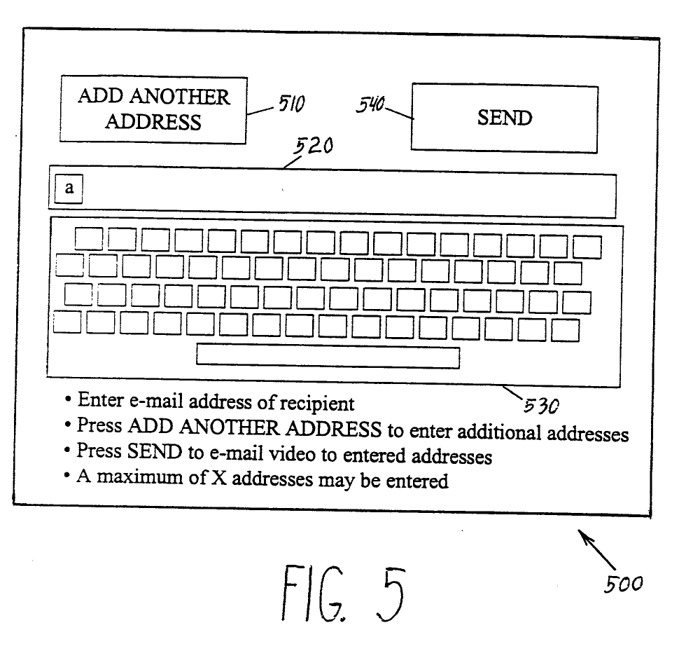

FIG. 5 shows an address screen 500 that is displayed after the full motion video or still snapshot message has been satisfactorily recorded and compressed, and it allows the user to enter an e-mail address or addresses and thereby designate a recipient or recipients. The address screen 500 contains information explaining the operation of this stage of the process, an add address button 510, an address display window 520, a keyboard display 530, and a send button 540. The user presses the add address button 510 to initiate the input of an e-mail address of a recipient. After pressing the add address button 510, the user may enter an e-mail address via the keyboard display 530. The entered address is displayed in the address display window 520. When the address is complete, the user may press the add address button 510 again to add another address of another recipient, or may press the send button 540 to proceed to the next step of the process.

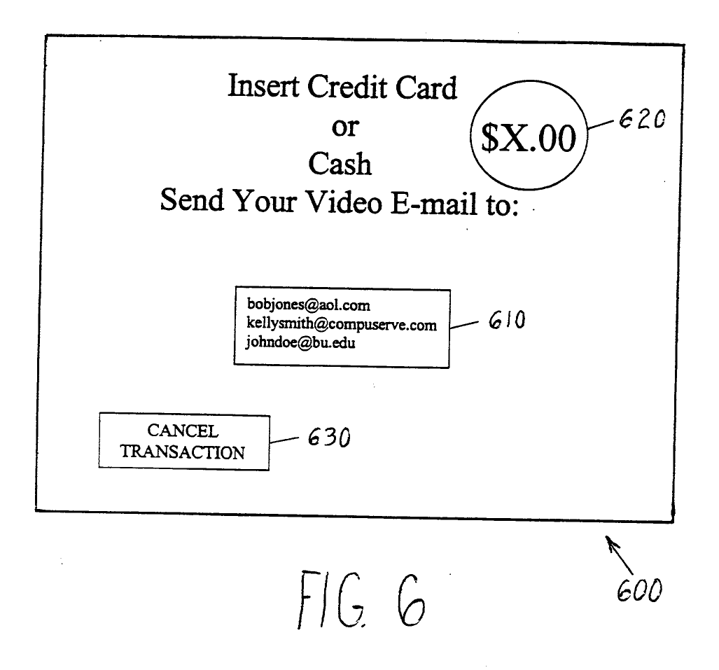

FIG. 6 shows a payment screen 600 that is displayed after the e-mail address or addresses have been entered. The payment screen 600 allows the user to choose the method of payment and pay for the full motion or still snapshot e-mail message before it is transmitted. The payment screen 600 contains descriptive text, an address display window 610, a price display window 620, and a cancel button 630. The address display window 610 displays the e-mail address or addresses of the intended recipients as a confirmation of the address entry process. The price display window 620 displays the fee the user must pay before the process will be completed and the video e-mail message will be sent. The cancel button 630 allows the user to cancel the transaction if desired. However, if the user enters payment as shown in the price display window 620, the video e-mail message will be sent and the process will proceed to the next step.

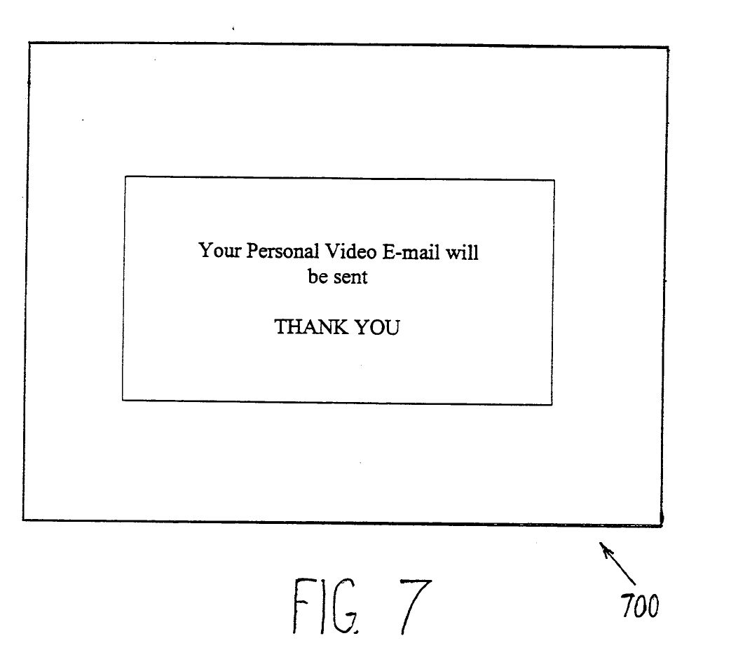

FIG. 7 shows a final screen 700 that is displayed at the end of the process after payment has been made and the video or photographic e-mail message has been sent to the intended recipient or recipients. The final screen 700 contains text communicating that the video e-mail message has been sent and the transaction has been completed.

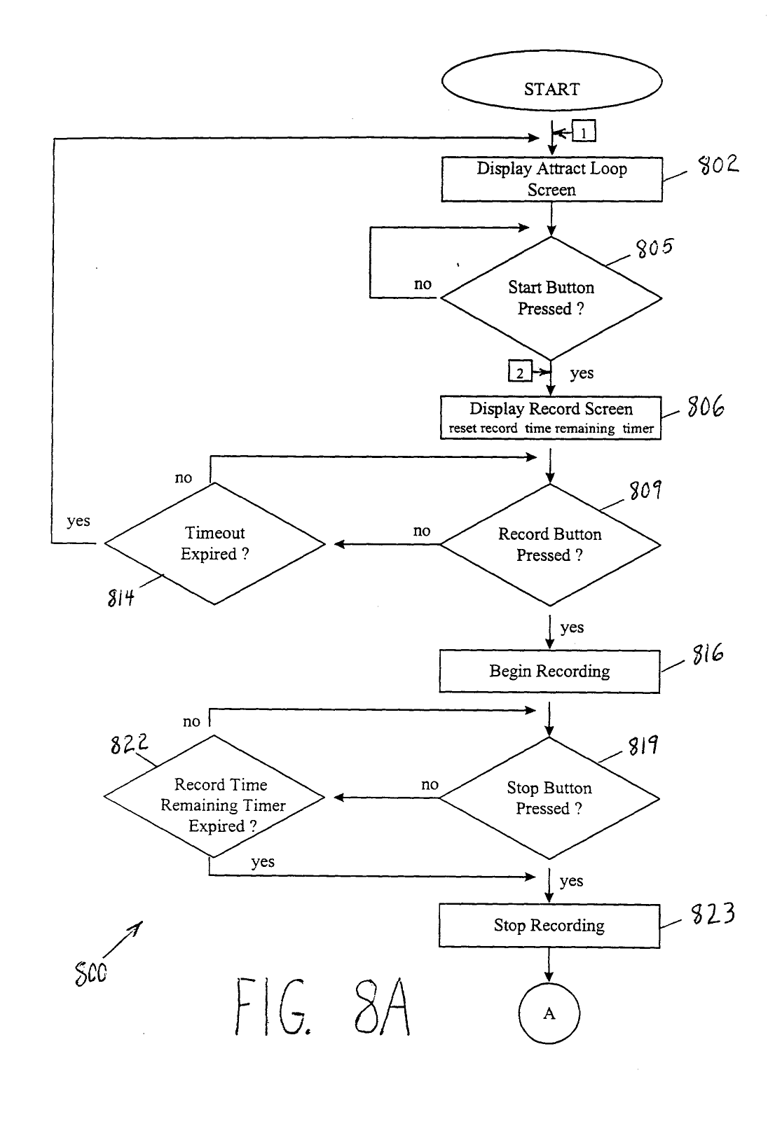

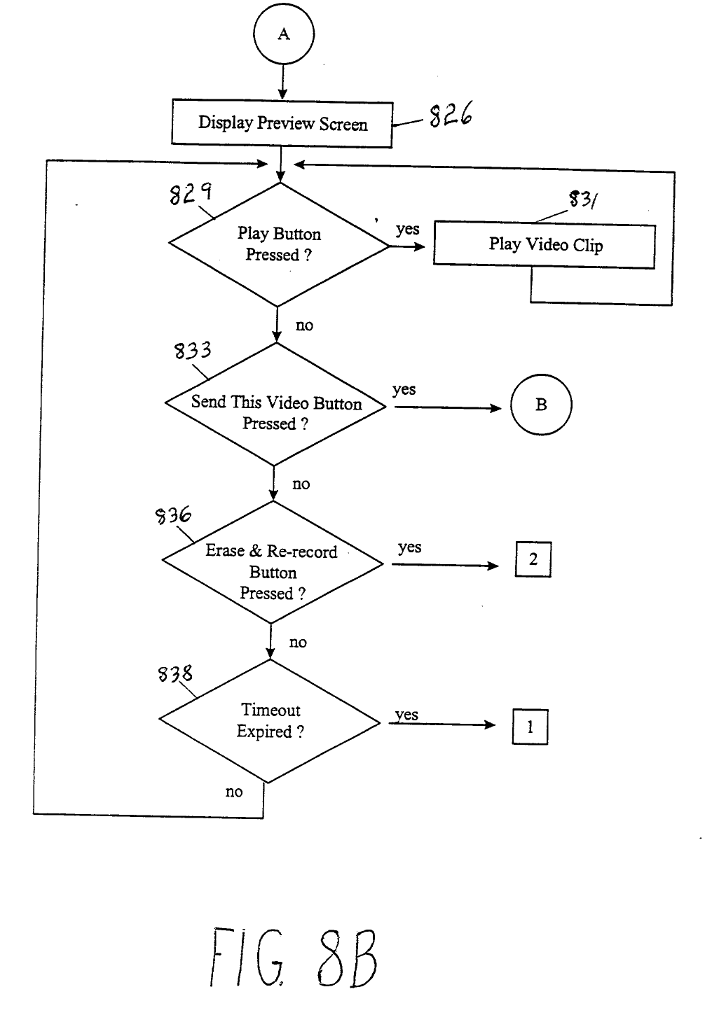

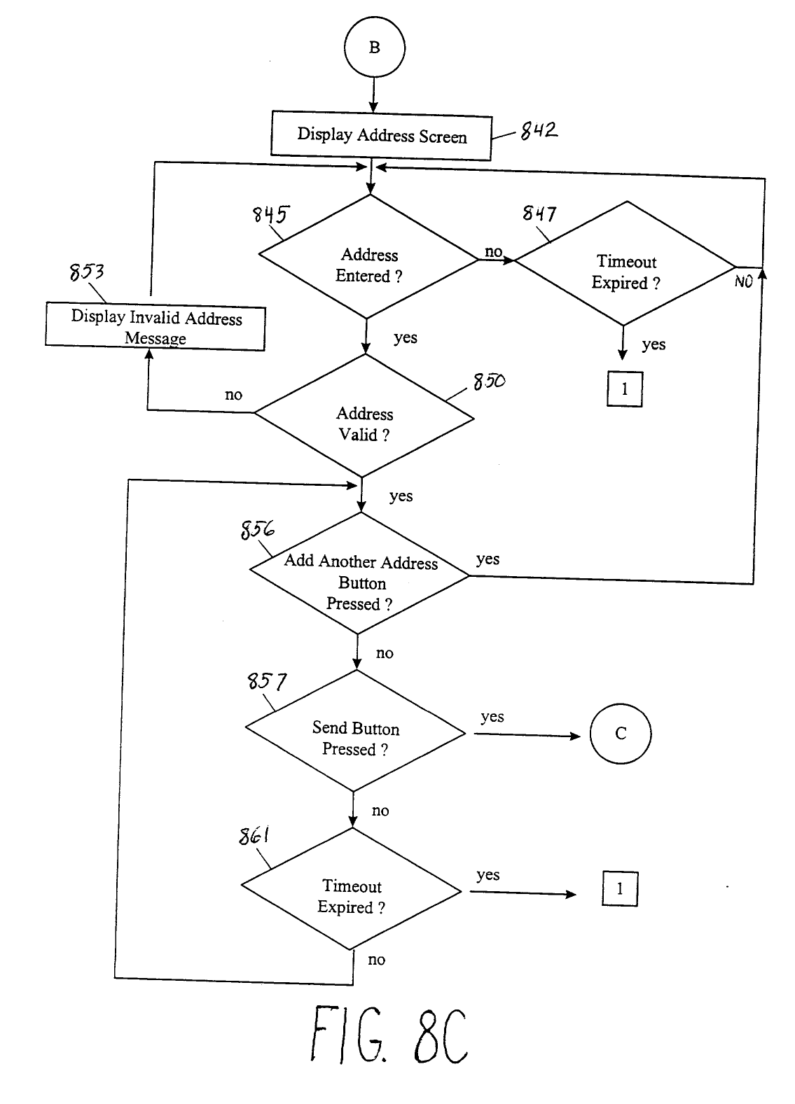

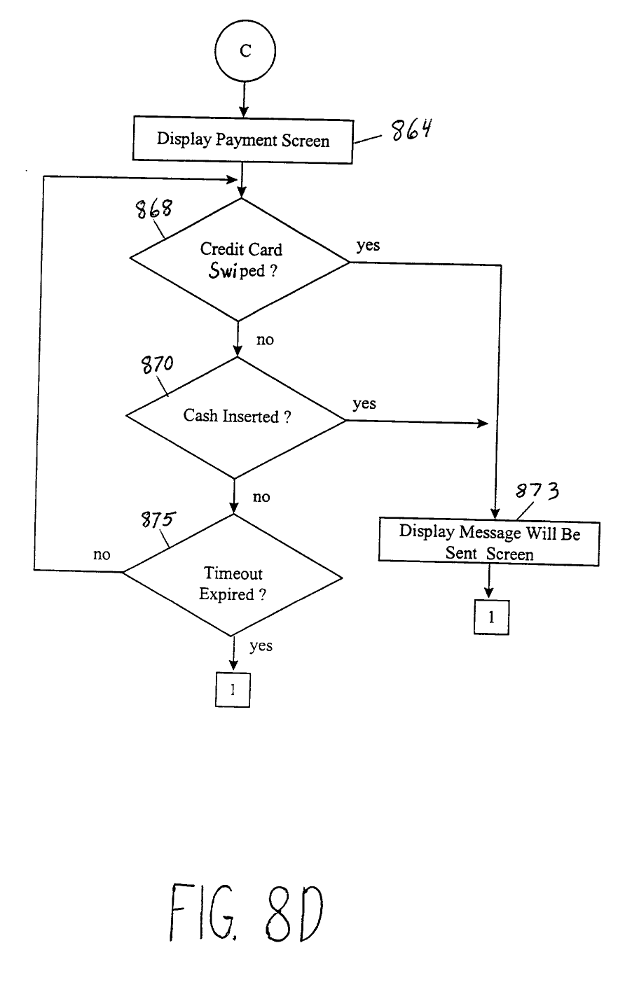

FIGS. 8A-8D show a flowchart 800 of the preferred embodiment of the method of the present invention. In step 802, the video e-mail kiosk 100 displays an attract loop in the inactive screen display 200. The attract loop is a continuous loop video display that is played when the video e-mail kiosk 100 is inactive or on stand-by. The function of the inactive screen display 200 is to demonstrate the features of the video e-mail kiosk 100 concerning creating a full motion video or still snapshot message, and to that end may display sample full motion video clips or still snapshots as examples of the end result. The inactive screen display 200 may also display a start button 220 which may be pressed by a user.

In step 805, the start button 220 is monitored. If the start button 220 has not been pressed, the method branches back onto itself at step 805. If the start button 220 has been pressed, the method proceeds to step 806.

In step 806, the record screen 300 is displayed. The record screen 300 presents the user with buttons that can be pressed to control the recording of a video message.

In step 809, the record button 310 is monitored. If the record button 310 has not been pressed, the method branches to step 814, where a timer is monitored. If the record button 310 has been pressed, the method proceeds to step 816.

In step 814, if the record button timer has not expired, the method branches back to step 809. Else, the method defaults back to step 802 and the inactive screen display 200 is displayed. The purpose of the record button timer and step 814 is to return the video e-mail kiosk 100 to an inactive mode if the user does not continue with the transaction.

In step 816, the video e-mail kiosk 100 begins recording the video message by means of the digital video camera 130 and the microphone 140.

In step 819, the stop button 320 of the record screen 300 is monitored. If the stop button 320 has not been pressed, the method proceeds to step 822, else it proceeds to step 823.

In step 822, a record time remaining timer is monitored. If the timer has not expired, the method branches back to step 819, where the stop button 320 is checked again. If the timer has expired, the method proceeds to step 823. The monitoring of the stop button 320 in step 819 in combination with the monitoring of the record time remaining timer in step 822 serve to limit the length of recording time to a preset time dictated by the record time remaining timer. However, if the stop button 320 is pressed by the user before the record time remaining timer expires, the length of the video recording will be less than the period of the maximum recording time.

In step 823, the recording of the video message is stopped, by either a press of the stop button or by the expiration of the record time remaining timer. In an alternative embodiment, the video recording steps 809-823 of FIG. 8A may be replaced by a step of taking a still digital snapshot.

Referring now to FIG. 8B, in step 826 the preview screen 400 is displayed. The purpose of the preview screen 400 is to allow the user to view the full motion video or still snapshot message that was recorded in steps 816-823 above, and decide whether to accept or reject the recorded message.

In step 829, the play button 420 of the preview screen 400 is monitored. If the play button 420 has been pressed, the method proceeds to step 831, else it proceeds to step 833.

In step 831, the previously recorded video message is played back to the user through the image window 430 of the preview screen 400. In an alternative embodiment, the video playback steps 829 and 831 may not be needed if the user is reviewing a still snapshot e-mail message. Step 831 also includes the video compression step (not shown). The processing wait screen 450 is displayed while the video is being compressed, with playback commencing when the compression is complete.

In step 833, the send button 450 is monitored. If the send button 450 has been pressed, the method proceeds to step 842 of FIG. 8C. Else, the method proceeds to step 836. The send button 450 is pressed by the user when the recorded video or photographic message is satisfactory and is accepted by the user.

In step 836, the erase button 410 is monitored. If the erase button 410 has been pressed, the method branches back to step 806, where the record screen 300 is displayed and a new video message may be recorded by the user. If the erase button 410 has not been pressed, the method proceeds to step 838.

In step 838, a preview timer is monitored. If the preview timer has expired, the method defaults back to step 802 and the inactive screen display 200 is displayed. If the preview timer has not expired, the method branches back to step 829 and the video e-mail kiosk 100 waits for a button of the preview screen 400 to be pressed. In this manner, the video e-mail kiosk 100 displays the preview screen 400 for a predetermined amount of time as dictated by the preview timer period. During the preview timer period, the user may select from the play (preview) button 420, the send button 450, or the erase button 410. If the user does not select one of the above buttons during the preview timer period, the video e-mail kiosk 100 will not remain in the preview screen 400, but will default back to the inactive state and display the inactive screen display 200.

Referring now to FIG. 8C, in step 842 the address screen 500 is displayed. The address screen 500 allows the user to designate an intended recipient or recipients by entering an email address or addresses.

In step 845, the video e-mail kiosk 100 determines whether an e-mail address has been entered. If an address has not been entered, the method branches to step 847, else the method proceeds to step 850.

In step 847, an address entry timer is monitored. If the address entry timer has not expired, the method branches back to step 845 to wait for an address to be entered. If the address entry timer has expired, the method defaults back to step 802 and the inactive screen display 200 is displayed.

In step 850, the video e-mail kiosk 100 determines whether the e-mail address is valid by checking the entered e-mail address for a standard e-mail address format. If the address is invalid, the method branches to step 853, where an error message is displayed, and then the method branches further back to step 845 where address entry may again be attempted by the user. If the address is valid, then the method proceeds to step 856.

In step 856, the address button 510 is monitored. If the address button 510 has been pressed, the method branches back to step 845, whereupon another address may be entered by the user. Else, the method proceeds to step 857.

In step 857, the send button 540 of the address screen 500 is monitored. If the send button 540 has been pressed, the method proceeds to step 864 of FIG. 8D, else it proceeds to step 861.

In step 861, the address screen timer is monitored. If the address screen timer has expired, the method defaults back to step 802 and the inactive screen display 200 is displayed. Else, the method branches back to step 856. In this manner, the video e-mail kiosk 100 displays the address screen 500 and waits for a button press by the user for a predetermined period of time as given by the address screen timer.

Referring now to FIG. 8D, in step 864 the payment screen 600 is displayed. The payment screen 600 provides the user with payment options so that the user can pay for the transaction.

In step 868, the credit card acceptor 160 is monitored. If a credit card has been offered, the method proceeds to step 873, else it proceeds to step 870.

In step 870, the cash acceptor 170 is monitored. If cash payment has been offered, the method proceeds to step 873, else it proceeds to step 875.

In step 873, the final screen 700 will be displayed. The final screen 700 informs the user that the full motion video or still snapshot e-mail message has been sent. After step 873, a final display timer is monitored (not shown), which after expiration defaults back to step 802 and the inactive screen display 200 is displayed. In this manner, the final screen 700 is displayed for a predetermined period of time before the video e-mail kiosk 100 returns to an inactive mode.

In step 875, a payment timer is monitored. If the payment timer has not expired, the method branches back to step 868, and the video e-mail kiosk 100 waits for a predetermined period of time as given by the payment timer. If the payment timer has expired, the method defaults back to step 802 and the inactive screen display 200 is displayed. In this manner, the payment timer gives the user a time period in which to tender payment before defaulting back to an inactive state.

While the invention has been disclosed in detail above, the invention is not intended to be limited strictly to the invention as disclosed. It is evident that those skilled in the art may now make numerous uses and modifications of and departures from the specific embodiments described herein without departing from the inventive concepts. For example, the payment steps of FIG. 8D may be inserted between steps 805 and 806 of FIG. 8A. In this way, a user must pay for the transaction before being allowed to record and preview a video message. In this alternative embodiment, users such as children will be prevented from occupying the kiosk for long periods of time by recording and previewing video images, without intending to ever send the message to a recipient.

What is claimed is:

1. A computer-implemented method for creating and sending a video e-mail message from a kiosk, comprising the steps of:
a) recording a video message;
b) requesting an e-mail address of an intended recipient; and
c) sending said video message to said intended recipient at said e-mail address.

2. The computer-implemented method for creating and sending a video e-mail message of claim 1, wherein the step of recording a video message further includes displaying an attract screen showing sample video messages.

3. The computer-implemented method for creating and sending a video e-mail message of claim 2, wherein said attract screen is a continuously playing video loop.

4. The computer-implemented method for creating and sending a video e-mail message of claim 2, wherein said attract screen displays recording options.

5. The computer-implemented method for creating and sending a video e-mail message of claim 1, also including the step of previewing a recorded video message prior to the message being sent to said recipient.

6. The computer-implemented method for creating and sending a video e-mail message of claim 1, also including the step of optionally re-recording said video message.

7. The computer-implemented method for creating and sending a video e-mail message of claim 1, wherein said e-mail address is checked for validity.

8. The computer-implemented method for creating and sending a video e-mail message of claim 1, wherein said video message is sent to multiple e-mail recipients.

9. The computer-implemented method for creating and sending a video e-mail message of claim 1, also including the step of receiving a payment in order to send said video message.

10. The computer-implemented method for creating and sending a video e-mail message of claim 1, also including the display of a transmission completed message after said video message has been sent.

11. The computer-implemented method for creating and sending a video e-mail message of claim 1, wherein the step of recording a video message includes recording a digital still snapshot.

12. The computer-implemented method of claim 1, wherein the step of recording a video message includes recording a full motion video.

13. A video e-mail kiosk for creating and sending a video e-mail message, comprising:
a display device capable of displaying video and computer graphics;
an input device capable of accepting input from a user;
a digital video camera;
a microphone;
a digital network communications link; and
a processor connected to said display device, said input device, said digital video camera, said microphone, and said digital network communications link, and capable of accepting input from a user and generating display output, and further capable of converting a video input from said digital video camera and an audio input from said microphone into a digital video e-mail message and transmitting said digital video e-mail message over said digital network communications link.

14. The video e-mail kiosk of claim 13, wherein said video e-mail kiosk further includes a payment acceptor.

15. The video e-mail kiosk of claim 14, wherein said payment acceptor is a credit card payment acceptor.

16. The video e-mail kiosk of claim 14, wherein said payment acceptor is a currency payment acceptor.

17. The video e-mail kiosk of claim 13, wherein said video e-mail kiosk further includes an audio speaker for playing an audio component of said digital video e-mail message.

18. The video e-mail kiosk of claim 13, wherein said display device and said input device further comprise a touch screen monitor.

19. The video e-mail kiosk of claim 13, wherein said processor further includes a communications card connected to said digital network communications link.

20. The video e-mail kiosk of claim 13, wherein a recorded video e-mail message can be replayed over said display device.

21. The video e-mail kiosk of claim 13, wherein said video camera is capable of taking a still digital snapshot.
